(19) United States
(12) Patent Application Publication
(10) Pub. No.: US 2012/0023497 A1
(43) Pub. Date: Jan. 26, 2012

(54) ELECTRONIC DEVICE WITH NETWORK ACCESS FUNCTION

(75) Inventors: TING-KAI WANG, Tu-Cheng (TW); WEN-WEN JIANG, Shenzhen City (CN); LI HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/915,055

(22) Filed: Oct. 29, 2010

(30) Foreign Application Priority Data
Jul. 21, 2010 (CN) 201010232799.9

(51) Int. Cl. G06F 9/46

(52) U.S. Cl. 718/102

(57) ABSTRACT

An electronic device with network access function includes an input unit, a storage unit, a wireless network unit and a processing unit. The processing unit includes a scheduling module, a determining module, an accessing module and a downloading module. The scheduling module is configured to receive input from user and schedule online tasks. The determining module is configured to determine when it is time to perform a scheduled task. The accessing module is configured to navigate for the location of the desired information according to the user input when it is time for the scheduled task, and the downloading module is configured to download the desired information according to the user input, and store the desired information in the storage unit.

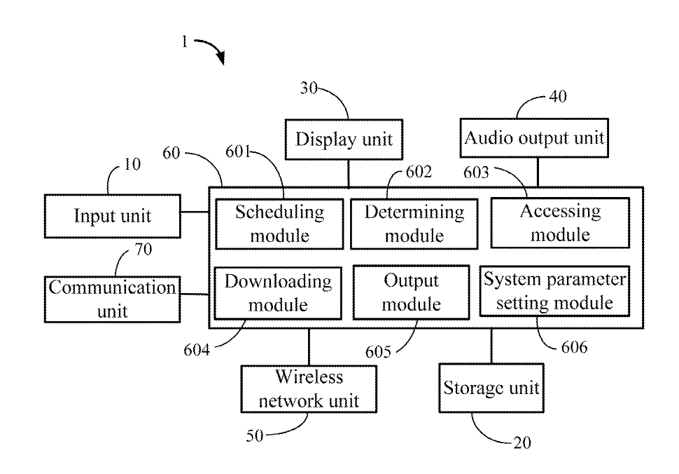

### BACKGROUND

1. Technical Field

The present disclosure relates to electronic devices and, more particularly, to an electronic device capable of automatically accessing a network and performing a scheduled task.

2. Description of Related Art

Many electronic devices, such as smart phones, E-book readers, and digital photo displays, cannot automatically access networks such as the Internet to perform scheduled tasks such as downloading desired information, that is, if a user wants to download information at a specific time, the user must manually perform operations on an electronic device at hand at the specific time, which can be very inconvenient as well as time consuming and troublesome.

Therefore, it is desirable to provide an electronic device with network access function to solve the problem mentioned above.

### BRIEF DESCRIPTION OF THE DRAWINGS

The components of the drawing are not necessarily drawn to scale, the emphasis instead being placed upon clearly illustrating the principles of an electronic device with internet access function.

The drawing is a schematic view of an electronic device with network access function in accordance with an exemplary embodiment.

### DETAILED DESCRIPTION

Referring to the drawing, an electronic device 1 includes an input unit 10, a storage unit 20, a display unit 30, an audio output unit 40, a wireless network unit 50, and a processing unit 60. The input unit 10, the storage unit 20, the display unit 30, the audio output unit 40, and the wireless network unit 50 are electrically connected to the processing unit 60.

The input unit 10 is configured to generate signals in response to user input. The input unit 10 may be, for example, a keypad or a touch pad. The storage unit 20 is used to store multimedia files. The storage unit 20 may be a memory card, such as a CF card, or an SD card.

The display unit 30 is configured to display information. The display unit 30 may be an LCD screen or an electronic paper screen. The display unit 30 can also be a touch-sensitive screen, so users can operate the electronic device 1 through the input unit 10 in combination with the display unit 30. The audio output unit 40 is configured to output audio information. The audio output unit 40 may be a speaker.

The wireless network unit 50 is configured to communicate the device 1 with network. In this embodiment, the electronic device 1 may include a button (not shown) for enabling and disabling the wireless communication unit 50. The wireless communication unit 50 may be enable and disabled through other ways, for example, by clicking a displayed icon.

The processing unit 60 includes a scheduling module 601, a determining module 602, an accessing module 603, a downloading module 604, and an output module 605.

The scheduling module 601 can receive input from user scheduling online tasks. The user input may include time and date for the device 1 to automatically go online on a network such as the Internet, and url or other navigating instructions, and specific file or feed information for downloading wanted information.

The determining module 602 is configured to determine when it is time to perform a scheduled task.

The accessing module 603 is configured to navigate for the location of the desired information according to the user input when it is time for the scheduled task.

The downloading module 604 is configured to download the desired information according to the user input, and store the desired information in the storage unit 20.

The output module 605 is configured to output the desired information to the display unit 30 and/or the audio output unit 40 on command.

For better understanding the present disclosure, an example is given to illustrate the present disclosure. If a user wants to obtain latest songs from the webpage corresponding to www.QQ163.com.cn at 10:00 am every Sunday, the user inputs “10:00 am, Sunday”, “www.QQ163.com.cn”, “latest songs”, and “download” to the device 1. The device 1 can automatically access the webpage corresponding to www.QQ163.com.cn at 10:00 am, on Sunday, and search for and download the latest songs from the webpage.

The processing unit 60 further includes a system parameter setting module 606, which can be used to set system parameter values, for example, time, display parameter values, and the like.

The electronic device 1 further includes a communication unit 70. The device 1 can communicate with external electronic devices through the communication unit 70. The communication unit 70 may include any one or more of a BLUETOOTH unit, an infrared unit, a USB interface, and a WIFI unit, for example.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with network access function, comprising:
an input unit configured to generate signals in response to user input;
a storage unit;
a wireless network unit configured to communicate with network; and
a processing unit comprising:
a scheduling module configured to receive the signals from the input unit and schedule online tasks;
a determining module configured to determine when it is time to perform a scheduled task;
an accessing module configured to navigate for the location of the desired information according to the user input when it is time for the scheduled task; and
a downloading module configured to download the desired information according to the user input, and store the desired information in the storage unit.

2. The electronic device according to claim 1, wherein the input unit is a keypad or a touch pad.

3. The electronic device according to claim 1, further comprising a display unit and an audio output unit, wherein the display unit is configured to display information, and the audio output unit is configured to output audio information.

4. The electronic device according to claim 3, wherein the display unit is an LCD screen or an electronic paper screen.

5. The electronic device according to claim 3, wherein the display unit is a touch-sensitive screen.

6. The electronic device according to claim 3, wherein the processing unit further comprises an output module configured to output the desired information to the display unit and/or the audio output unit on command.

7. The electronic device according to claim 1, further comprising a system parameter setting module used to set system parameter values.

8. The electronic device according to claim 1, further comprising a communication unit, wherein the electronic device communicates with external electronic devices through the communication unit.

9. The electronic device according to claim 8, wherein the communication unit comprises a BLUETOOTH unit, an infrared unit, a USB interface, and a WIFI unit.

10. The electronic device according to claim 8, wherein the communication unit comprises a unit selected from the group consisting of a BLUETOOTH unit, an infrared unit, a USB interface, and a WIFI unit.
